(19) United States
(12) Patent Application Publication
(10) Pub. No.: US 2007/0056671 A1
(43) Pub. Date: Mar. 15, 2007

(54) Bicycle tube tire

(76) Inventor: Wolfgang Klapp, Korbach (DE)

Correspondence Address: GREENBLUM & BERNSTEIN, P.L.C., 1950 ROLAND CLARKE PLACE, RESTON, VA, 20191, US

(21) Appl. No.: 10/561,871

(22) PCT Filed: Apr. 21, 2004
(86) PCT No.: PCT/EP04/04187

§ 371 Date: Aug. 1, 2006

(30) Foreign Application Priority Data
Jul. 2, 2003 (DE) 10329699.9

(51) Int. Cl. B60C 3/02

(52) U.S. Cl. 152/453; 152/514; 152/513

(57) ABSTRACT

The invention relates to a bicycle tube tire comprising a tubular casing (2) closed in an annular manner, a rubber tread (4), an air sealing means (1) and a webbing (3). To fix the bicycle tube tire onto the rim simply and quickly, the webbing (3) is made of a fabric comprising reinforcement carriers extending at least in the circumferential direction of the tire and made of a material which contracts when dampened with water or an aqueous solution and subsequently dried.

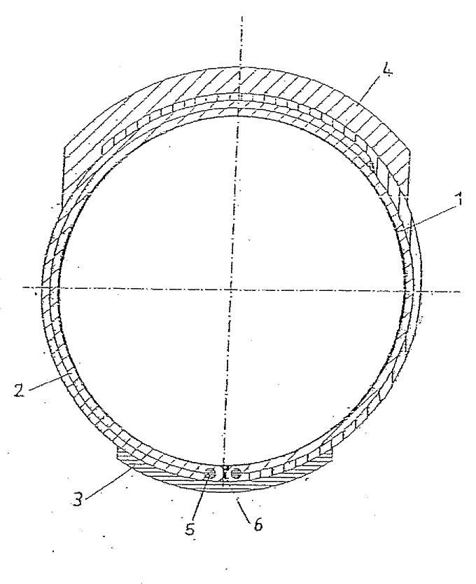

The invention relates to a bicycle tube tire comprising a tubular casing closed in an annular manner, a rubber tread, an air sealing means and a webbing.

Tube tires are understood to be such pneumatic tires having a tubular casing closed in an annular manner. For bicycles, such tires are mostly provided for use in racing and pertinent training purposes. Tube tires offer slight weight advantages and a better riding comfort as compared to wired-on tires, which are held in rim flanges with lateral wire reinforcements.

As a rule, tube tires comprise a tube made of an air-impermeable rubber mixture, which tube is encased by the casing, whereby the casing of rubberized full fabric or at least of two rubberized intersecting cord plies is generally closed with a seam. The seam can be provided with an inner protective flap, e.g., made of polyamide, on the side facing the inner tube. As a protection against rim chafing and for fastening the tire on the rim, the tube tire has a webbing, also called a seam protective flap, on the side facing the rim.

In addition to the tube tires described above, there are also such that have an air-impermeable casing rubberization instead of the air-impermeable inner tube. Furthermore, tube tires without a seam are known.

The tube tires, which already bear firmly against the rim during inflation (shrink tires), are additionally fixed to the rim in order to improve the stability in turns and prevent the tire from detaching itself from the rim in the case of a puncture.

It has long been known to use adhesive tapes for fixing tube tires onto rims, which adhesive tapes are attached in a corresponding manner between rim and tube tire. Mounting with the aid of these tapes is time-consuming, the adhesive tapes are very easily soiled and it is almost impossible to subsequently correct a tire that has been installed in a displaced manner.

A further alternative way of fixing tube tires onto rims is the use of tube tire putty or glue which has to be applied, frequently in several layers, to the inner area of the rim and/or to that surface part of the tube tire coming into contact with the rim, whereby hardening times of approx. 24 h frequently have to be accepted for a durable connection. Alignment is difficult on the slowly hardening putty or glue. If tires glued with putty are removed from the rim, putty residues frequently remain on the rim, which residues are very difficult to remove completely. Tube tire putty or glue is generally very expensive, and the full adhesive force is often maintained only for a limited period of time.

From DE 37 04 087 A1 it is further known to provide a tube tire with a tube band and the rim with a rim band, whereby the surfaces of the bands engaging with one another are provided at least along selected partial areas with roughened surfaces producing a form closure between one another or similar surface structures complementing one another in a positive manner. In this manner, a relative movement between tube tire and rim is to be rendered largely impossible and the disadvantages of adhesive tape and putty are to be avoided. Advantageously, Velcro bands known per se are used. With this variant of fixing, a centering of the tube tire is hard to achieve, as the tire must be placed onto the Velcro band in the correct position from the start. A subsequent turning is not possible, as the form closure is already engaged then.

Furthermore, this variant has the disadvantage that permanent connections must be created both between the tube band and the tube tire and between the rim band and the rim, which is laborious and whereby attention must be paid to a good connection in two places.

The object of the invention is to make available a bicycle tube tire that can be fixed onto the rim simply and quickly.

The object is attained according to claim 1 in that the webbing is made of a fabric comprising (when the tire is mounted) reinforcement carriers extending at least in the circumferential direction of the tire and made of a material which contracts when dampened with water or an aqueous solution and subsequently dried.

The basic concept of the invention lies in that the contracting force of a special material is used for fixing the tire onto the rim, whereby this material is incorporated at the same time into a component customarily present on the tube tire, namely the webbing, without the webbing losing its effect as protection against rim chafing. The disadvantages of adhesive tapes, tire glues and the variant with Velcro fastening, such as that it is easily soiled, alignment is difficult and additional accessories are used, are avoided. In order to fix the tire onto the rim, the webbing is simply dampened with water or an aqueous solution and immediately mounted with the webbing facing the rim well. After drying, the tire is firmly fixed onto the rim by the contracted webbing.

The fabric for the webbing can comprise reinforcement carriers made of the contracting material in the circumferential direction of the tire and in the axial direction. But it is sufficient if the fabric for the webbing comprises reinforcement carriers (fibers, threads or yarns) made of the contracting material merely in the circumferential direction of the tire, with reference to the mounted tire, as the contracting forces applied on the circumference and acting in the radial direction (concentrically) are required for fixing the tire onto the rim. The reinforcement carriers extending in the axial direction can be made of a different material. For instance, a fabric can thus be used with warp made of a material contracting when dampened and dried and with weft made of cotton, polyester or polyamide, a so-called hybrid fabric, whereby the latter materials for the weft are as a rule more inexpensive than the contracting material, so that cost advantages can result as compared to a fabric made completely of the material contracting when dampened and dried.

The materials for the reinforcement carriers, which contract when dampened with water or an aqueous solution and subsequently dried, i.e., after the removal of the water, can be polymeric materials having amorphously oriented areas along the reinforcement carrier, which areas change into an amorphously relaxed state upon contact with water, which state is frozen by drying. In the amorphously oriented state, the polymer molecules are present in a linear state, whereas they change into a more unordered and folded structure in the relaxed state.

The preferred contracting material for the reinforcement carriers are polyvinyl alcohols, as these show a particularly good contracting behavior. Fibers made of polyvinyl alcohols are available, e.g. under the name Mewlon from Unitika.

The bicycle tube tire according to the invention can also be produced according to customary methods known for tube tire construction, whereby the webbing is vulcanized onto the casing preferably by means of a coating vulcanizable under heat or at room temperature, in order to ensure a high separating strength between casing and webbing.

The invention is explained in more detail below on the basis of an exemplary embodiment in conjunction with the FIGURE below, but without being restricted to this example.

The only FIGURE diagrammatically shows the section through a bicycle tube tire according to the invention.

The bicycle tube tire has an airtight inner tube 1 and a casing 2 made of rubberized cord fabric encasing this tube, which fabric is folded around cotton threads 5 (shown enlarged) such that two intersecting cord fabric plies that overlap below the rubber tread 4 are thereby produced. In the production of such a tire, the casing 2 is vulcanized together with the tread 4 as a so-called casing band and then placed around the already vulcanized inner tube 1 and sewed together, whereby the seam 6 is produced. In addition, the tire has a webbing 3 made of a fabric contracting when dampened and dried, e.g., of polyvinyl alcohol, that covers the seam 6. The webbing 3 can be attached to the tube tire in that the webbing 6 is repeatedly coated with a coating vulcanizable under heat, e.g., a gasoline-containing rubber solution, and after the drying of this layer, the webbing 3 is placed with the coated side, which has a certain green tack, onto the casing 2 over the seam 6. The webbing 3 is then vulcanized onto the casing 2 by means of a heating collar, which achieves a high separating strength. But it is also possible to coat the webbing 3 with a so-called self-vulcanizing solution that cures at room temperature and to thus realize a connection to the casing 2.

Mounting the tube tire according to the invention onto the rim can take place as follows: First, the rim is cleaned. Then the webbing 3 is dampened with water, e.g., by means of a sponge, and, if necessary, the rim is also wetted with water in order to provide a sufficient amount of water for the contracting. The tube tire is placed onto the rim immediately thereafter. After a slight inflation, the tire can still be aligned correctly in a simple manner, as the material of the webbing 3 has not yet dried in the contracted form and thus hardened. Then the tire is inflated completely and the webbing 3 is left to dry. A tire produced in this manner has a high stability in turns and does not detach itself from the rim in the case of a puncture.

### LIST OF REFERENCE NUMBERS

(is part of the specification)

1 Innertube
2 Casing
3 Webbing
4 Tread
5 Cotton thread
6 Seam

1. Bicycle tube tire comprising a tubular casing (2) closed in an annular manner, a rubber tread (4), an air sealing means (1) and a webbing (3), characterized in that the webbing (3) is made of a fabric comprising reinforcement carriers extending at least in the circumferential direction of the tire and made of a material which contracts when dampened with water or an aqueous solution and subsequently dried.

2. Bicycle tube tire according to claim 1, characterized in that the fabric has reinforcement carriers made of the contracting material in the circumferential direction of the tire and in the axial direction.

3. Bicycle tube tire according to claim 1, characterized in that the fabric has reinforcement carriers made of the contracting material in the circumferential direction of the tire and reinforcement carriers made of cotton, polyester or polyamide in the axial direction.

4. Bicycle tube tire according to claim 1, characterized in that the contracting material is a polyvinyl alcohol.

5. Bicycle tube tire according to claim 1, characterized in that the webbing (3) is vulcanized onto the casing (2) by means of a vulcanizable coating.
